(19) United States
(12) Patent Application Publication
(10) Pub. No.: US 2008/0208728 A1
(43) Pub. Date: Aug. 28, 2008

(54) Fractional Forward Contracts

(76) Inventor: George Sugihara, Del Mar, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/576,870

(22) PCT Filed: Oct. 7, 2005
(86) PCT No.: PCT/US05/36354

§ 371 Date: Apr. 6, 2007

Related U.S. Application Data
(60) Provisional application No. 60/617,371, filed on Oct. 8, 2004.

(51) Int. Cl. G06Q 40/00

(52) U.S. Cl. 705/37

(57) ABSTRACT

A financial instrument, called a fractional forward contract, and a way of using it to apportion risk between parties (100 and 170) contracting to buy (160) and sell (110) a commodity at a future date by providing for parties (100 and 170) to buy (160) and sell (110) a specified fraction of a commodity that the supplier (100) has in his inventory on a specific date, rather than a specified quantity.

### RELATED APPLICATIONS

This application claims the benefit of priority of U.S. Provisional Application Ser. No. 60/617,371, filed Oct. 8, 2004, which is incorporated herein by reference.

### FIELD OF THE INVENTION

The present invention relates to instruments and methods for apportioning risk and reward between parties contracting to buy and sell a commodity at a future date.

### BACKGROUND OF THE INVENTION

Businesses often need to know their future costs to permit accurate budgeting and to manage their cash efficiently. Commodity futures markets, for example, arose from the need of farmers and of their customers to lock in the price that would be paid for a farm commodity when it was actually harvested, and to provide the farmers with operating capital in advance of the harvest. In essence, such futures markets transferred price risk from those who wished to avoid it to those willing to accept it in the hopes of gaining a reward for doing so. Futures contracts now exist not only for agricultural products such as corn and wheat, but for livestock, petroleum products, and precious metals, among others. Similar desires to transfer risk from those exposed to it to those willing to accept it led to development of forward contracts (in which a contract is made at one time for delivery of the commodity later) and options.

Prices in general result from the interplay of supply and demand, but for some goods most of the variation in price results from variation in supply, with demand being relatively constant. Suppliers in such cases face a serious problem: a forward contract may oblige them at the settling date to provide more of the goods than they will actually have available.

Recognition of such a shortfall as the settling date approaches forces suppliers either to unwind part of their original forward position by either buying the commodity on the spot market to satisfy the contract or by entering into a second forward contract (this time as a purchaser, rather than a supplier, of the commodity) that offsets the anticipated shortfall. Since shortfalls in commodities commonly arise from factors that affect all suppliers (e.g., weather), unwinding forward positions near the settling date can require suppliers to bid against each other for what unexpectedly has become a scarce commodity, driving up the price, much like a short squeeze in the stock market.

Such price crunches obviate much of the purpose of the original forward contract, which was to transfer price volatility risk from suppliers to those willing to accept it. They arise in part because forward contracts are specified in terms of quantities of commodities that the parties agree to exchange.

In some industries shortfalls in the underlying commodity have an especially pernicious effect. In commercial fishing, for example, shortfalls motivate fishermen to try to catch still more fish from what is often an already depleted fishery, thereby exacerbating the original shortfall and jeopardizing future catches as well through a “tragedy of the commons” effect. The U.S. government, in one effort to address this problem, has instituted a program of individual transferable quotas that specify how many fish of a given species may be taken over a given period, as provided for in the Magnuson-Stevens Fishery Conservation and Management Act, Public Law 94-265, These individual transferable quotas may be bought and sold, much like pollution credits.

Thus a need exists for a way to apportion risk between buyers and sellers of commodities to mitigate the deleterious economic (and often environmental) effects of variations in supply of commodities.

### SUMMARY OF THE INVENTION

The present invention addresses this need by providing a financial instrument and a way of using it to apportion risk between parties contracting to buy and sell a commodity at a future date. This instrument, called a fractional forward contract, provides for parties to buy and sell not specified quantities of a commodity, but rather a specified fraction of the commodity that the supplier has in his inventory on a specific date.

A fractional forward contract for conducting trading of a commodity supplied by a supplier having an inventory of the commodity and a buyer of the commodity comprises an agreement that specifies a commodity, a unit of the commodity, such as a measure of weight, volume, or number, and an upper bound of the supplier's inventory, specified in the unit. It further specifies a fraction of the supplier's inventory, expressed in the unit, a contract period over which the supplier's inventory will be determined, a settling date, and a price per unit at which, on the settling date, the supplier will sell the fraction of the inventory.

### BRIEF DESCRIPTION OF THE DRAWINGS

FIG. 1 is a block diagram showing an overview of an exemplary computer-implemented system for establishing fractional forward contracts of the present invention.

FIG. 2 depicts the fields of an exemplary website offering page.

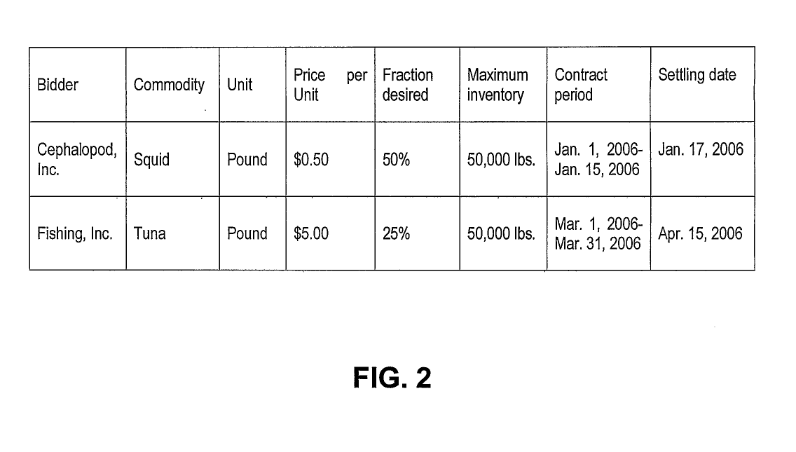

FIG. 3. shows the fields of an exemplary contract database entry.

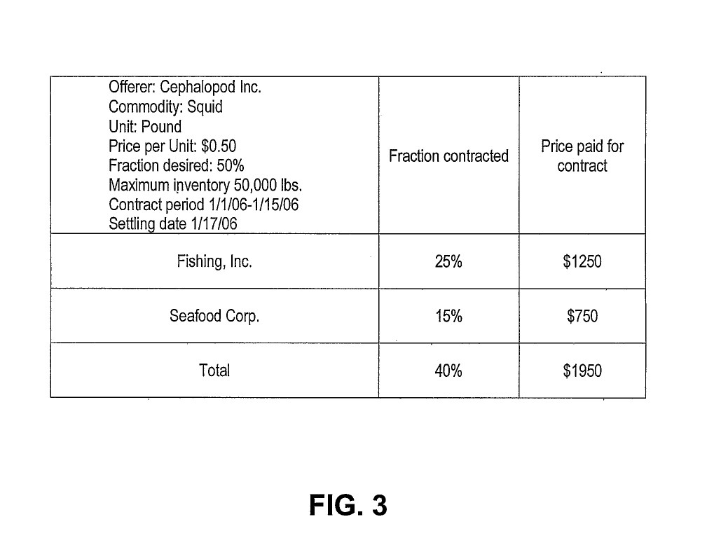

### DETAILED DESCRIPTION OF THE INVENTION

A supplier of a commodity wishing to offer a fractional forward contract regarding the commodity specifies the identity of the commodity, a unit by which the commodity will be measured (such as a measure of weight, volume, or number), and an upper bound of the supplier's inventory, i.e., the maximum quantity (expressed in the unit) that the supplier is willing to offer in the contract.

The supplier further specifies what fraction of his inventory, expressed in the unit, he wishes to offer in the contract, and a contract period over which the supplier's inventory will be determined. The fraction may be expressed as a percentage, or as a quotient, such as one-quarter, but in either case will of course be dimensionless. For example, the supplier may offer one-quarter of his inventory by weight (such as the pound, kilogram, or ton), by volume (such as the cubic foot or cubic meter), or by number, for items amenable to enumeration, depending on the nature of the commodity.

The supplier also specifies a contract period, which is the time over which his inventory will be assessed for the purposes of the contract. For example, a fisherman offering a fractional forward contract on the fish he catches over a two week fishing expedition, rather than the fish in his inventory on a given day, could specify a given two week period as the contract period.

The supplier further specifies a settling date, on which the trade will be consummated, and a price per unit at which, on the settling date, the supplier will sell the fraction of the inventory. In one embodiment, the supplier also sets the price the purchaser must pay to enter into the contract.

A purchaser accepting the supplier's offered fractional forward contract provides the supplier with the agreed-upon consideration, if any. In a preferred embodiment, the purchaser would purchase the fractional forward contract with cash or other financial instrument, but payment could also be made in kind. The supplier reports his inventory over the contract period, determines the appropriate fraction of it, as agreed in the fractional forward contract, and on the settling date, sells that fraction to the purchaser at the agreed-upon price per unit.

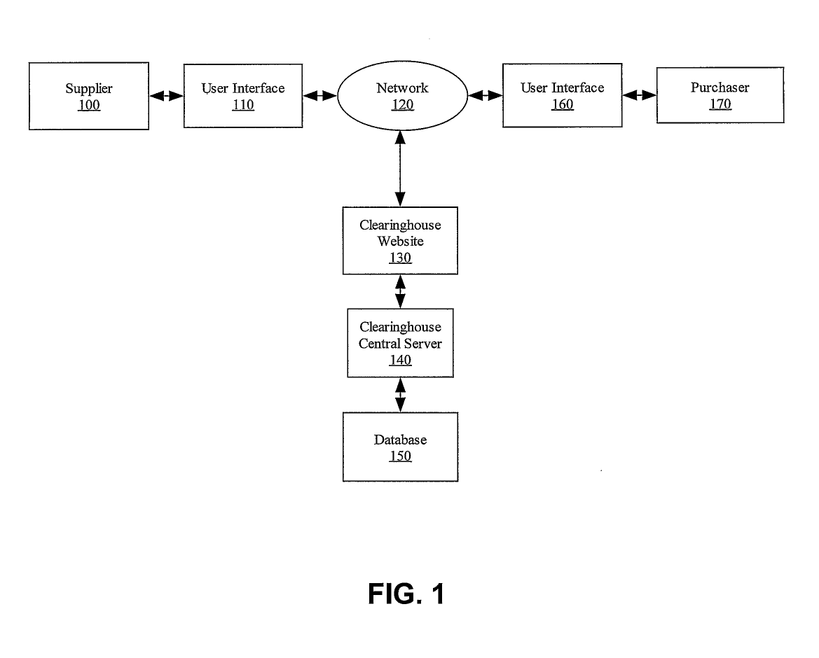

In a preferred embodiment, fractional forward contracts are offered and purchased through use of a system involving a computer. One or more suppliers transmit information relevant to offered fractional forward contracts to a central server, which maintains a database of fractional forward contracts on offer. Referring to FIG. 1, supplier 100 uses a conventional user interface 110 to access, via a network such as the Internet 120, clearinghouse website 130 where supplier 100 enters information relating to a fractional forward contract. The information entered is transmitted from website 130 to clearinghouse central server 140, which records the information in database 150. Server 140 transmits information from database 150 to website 130, which transmit the information over Internet 120 to a conventional user interface 160 for viewing by purchaser 170.

Website 130 lists information concerning the offered fractional forward contracts such as the commodity, the unit in which the commodity is measured, the price per unit, the maximum inventory possible, the fraction of inventory being offered for sale, and the settling date or date range pertaining to the fraction of inventory offered.

Purchaser 170 uses conventional user interface 160 to enters his purchase order, which is then transmitted via network 120, such as the Internet, to the central server 140 via website 130. Central server 140 receives the purchaser's transaction information, verifies the purchaser's identity and financial bona fides, then updates database 150 and website 130 to reflect the purchaser's transaction. The central server then optionally sends a communication to supplier 100 to indicate purchaser 170's acceptance of the offered fractional forward contract.

In one embodiment, the invention provides a system for trading fractional forward contracts on a commodity, comprising a first computer connected to a computer network, such as the Internet, and having a database for storing information relating to a fractional forward contract. The information includes a unit of the commodity, an inventory of the commodity, having an upper bound of a size specified in the unit, a fraction of the inventory, expressed in the unit, a contract period, over which the size of the inventory will be determined, a settling date, and a price per unit at which, on the settling date, the fraction of the inventory will be sold. The system further comprises a second computer connected to the computer network and having a user interface for viewing and communicating acceptance of the fractional forward contract.

In a preferred embodiment, communications taking place over the Internet or other network are encrypted for security, as is commonly done with financial transactions.

Fractional forward contracts inhibit over-exploitation of a resource by creating a disincentive to harvest when the resource is scarce and the prices are highest, making them especially useful in the commerce of commodities threatened with declining stocks. Moreover, they remove the sellers' risk of not having deliverable product at the settling date.

In one embodiment fractional forward contracts are used to trade in foodstuffs, such as agricultural products and seafood, the latter comprising fish, crustaceans, molluscs, and echinoderms. The term “fish” is intended to include pelagic species, groundfish, shallow flatfish, deep water flatfish, forage fish, and cartilaginous fish. Examples of such fish include tuna, salmon, swordfish, cod, mackerel, pollack, rockfish, halibut, flounder, turbot, sole, herring, smelt, shark, skate, and ray. Examples of crustaceans include lobsters, crabs, and shrimp, of molluscs include bivalves, gastropods, and cephalopods, such as clams, mussels, oysters, squid, and octopi. In a preferred embodiment, the fractional forward contract involves squid. An example of an echinoderm is sea urchin. In another embodiment, fractional forward contracts are used to trade specified portions of individual transferable quotas.

For example, a representative of Cephalopod, Inc., which wishes to hedge its risk by offering a fractional forward contract on its catch of squid, navigates to a website on a clearinghouse's server and enters information relating to the fractional forward contract Cephalopod wishes to offer. Specifically the representative indicates that the contract pertains to squid, that the unit is the pound, that the upper bound of Cephalopod's inventory, (in this case the capacity of their boat), is 50,000 pounds, and that Cephalopod is offering 50% of its catch, whatever it may be, during a contract period of Jan. 1, 2006 to Jan. 15, 2006, with a settling date of Jan. 17, 2006, and that Cephalopod is offering 50% of its catch at a price of $0.50 per pound. In one embodiment, Cephalopod would also specify the price to be paid to it for entering into the contract, such as $2500, which could be prorated for those wishing to accept the offer for less than the full fraction Cephalopod has offered. Cephalopod's offer is then entered into a database on a central clearinghouse server that displays the offer on the clearinghouse's website.

A first buyer, for Fishing, Inc., a squid processor navigates to the website on the clearinghouse's server, views Cephalopod's offer, and decides to accept 25% of Cephalopod's catch during the contract period, and agrees to pay $1250 for the contract. The clearinghouse's server updates the database and the website to reflect Fishing, Inc.'s purchase, and to show that the remaining 25% of Cephalopod's catch is still available.

A second buyer, this one for Seafood Corp., another squid processor, repeats the process followed by the first buyer and decides to accept 15% of Cephalopod's catch during the contract period, and to pay $750 for the contract. The clearinghouse's server updates the database and the website to reflect Seafood Corp.'s purchase, and to show that the remaining 10% of Cephalopod's catch remains available for contract.

Cephalopod's boat puts to sea and returns on Jan. 16, 2006 with a catch of 30,000 lbs. of squid. On the following day, the settling date of Jan. 17, 2006, Fishing, Inc. buys 25% of the catch, or 7500 lbs., at a price of $0.50 per pound, for a total of $3750. Seafood Corp. buys its contracted 15% of Cephalopod's catch, or 4500 lbs., at the same price, for a total of $2250. Cephalopod, Inc. still owns the remaining 60% of the catch, or 18,000 lbs., comprising the unaccepted portion of the fractional forward contract (10%) and the 50% of uncontracted inventory, which may, for example, be sold on the spot market.

The above description is by way of illustration only and is not intended to be limiting in any respect. Those of skill in the art will recognize that fractional forward contracts have utility beyond commercial fishing, and indeed have utility in trading any commodity in which the supply is variable and unpredictable. For example, fractional forward contracts can be used by suppliers of computer parts, such as semiconductor manufacturers and distributors, by producers and distributors of petroleum products, such as oil and natural gas. A semiconductor distributor could offer a fractional forward contract for a portion of his inventory of semiconductor chips at some future time, such as a financial quarter in much the same fashion as described above for the fisherman, except that the unit would be the number of chips, rather than weight or volume. Similarly, a distributor of petroleum products could offer a fractional forward contract on oil, specifying his inventory in the number of barrels, for example, or on natural gas, where the unit might be cubic feet at a given pressure.

From the foregoing non-limiting examples those skilled in the art of commodity trading will readily appreciate how to implement fractional forward contracts and recognize their utility in other areas of commerce that exhibit variable and unpredictable supplies of commodities.

1. A fractional forward contract for conducting trading of a commodity, comprising an agreement that specifies:
a unit of a commodity,
an inventory of the commodity, and an upper bound of the inventory, having a size specified in the unit,
a fraction of the inventory, expressed in the unit,
a contract period, over which the inventory will be determined,
a settling date, and
a price per unit, on the settling date, for the fraction of the inventory.

2. The contract of claim 1, further comprising a price for entering into the contract.

3. The contract of claim 1, wherein the commodity is an individual transferable quota.

4. The contract of claim 1, wherein the commodity comprises agricultural products.

5. The contract of claim 1, wherein the commodity comprises seafood selected from the group consisting of fish, crustaceans, molluscs, and echinoderms.

6.-17. (canceled)

18. The contract of claim 1, wherein the commodity comprises manufactured goods.

19. The contract of claim 1, wherein the commodity comprises a petroleum product selected from the group consisting of oil and natural gas.

20. The contract of claim 1, wherein the commodity comprises a semiconductor chip.

21. A method for conducting trading of a commodity, comprising:
specifying a plurality of trading parameters comprising:
a unit of the commodity,
an inventory of the commodity, and an upper bound of the inventory, having a size specified in the unit,
a fraction of the inventory, expressed in the unit,
a contract period, over which the inventory will be determined,
a settling date, and
a price per unit, on the settling date, for the fraction of the inventory;
wherein each of the specified plurality of trading parameters is incorporated into a contract for trading the commodity.

22. The method of claim 21, further comprising specifying a price for entering into the agreement.

23. The method of claim 21, wherein the commodity is an individual transferable quota.

24. The method of claim 21, wherein the commodity comprises agricultural products.

25. The method of claim 21, wherein the commodity is seafood selected from the group consisting of fish, crustaceans, molluscs, and echinoderms.

26.-39. (canceled)

40. The method of claim 21, wherein the commodity comprises manufactured goods.

41. The method of claim 21, wherein the commodity comprises a petroleum product selected from the group consisting of oil and natural gas.

42. The method of claim 21, wherein the commodity comprises a semiconductor chip.

43. A computer program for trading fractional forward contracts, the program comprising:
a plurality of instructions downloaded into and executed by a computer processor to:
(a) receive offering information comprising:
(i) a unit of a commodity,
(ii) an inventory of the commodity, and an upper bound of the inventory, having a size specified in the unit,
(iii) a fraction of the inventory, expressed in the unit,
(iv) a contract period, over which the size of the inventory will be determined,
(v) a settling date, and
(vi) a price per unit, on the settling date, for the fraction of the inventory,
(b) enter the offering information into a database,
(c) display the offering information to a purchaser,
(d) receive purchasing information relating to a purchase by the purchaser,
(e) update the database to reflect the purchase and final terms of the purchase; and
(f) generate a report summarizing the offering information and final terms of the purchase.

44. A computer-readable medium storing a computer program for trading fractional forward contracts, the program comprising:
a plurality of instructions downloaded into and executed by a computer processor to:
(a) receive offering information relating to a fractional forward contract, the information comprising:
(i) a unit of a commodity,
(ii) an inventory of the commodity, and an upper bound of the inventory, having a size specified in the unit,
(iii) a fraction of the inventory, expressed in the unit,
(iv) a contract period, over which the size of the inventory will be determined,
(v) a settling date, and
(vi) a price per unit at which, on the settling date, the fraction of the inventory will be sold,
(b) enter the offering information into a database,
(c) display the offering information to a purchaser,
(d) receive purchasing information relating to a purchase by the purchaser,
(e) update the database to reflect the purchase and final terms of the purchase; and
(f) generate a report summarizing the offering information and final terms of the purchase.

45. A system for trading fractional forward contracts on a commodity, comprising:
(a) a first computer connected to a computer network and having a database for storing contract terms relating to a fractional forward contract, the information comprising:
(i) a unit of the commodity,
(ii) an inventory of the commodity, and an upper bound of the inventory, having a size specified in the unit,
(iii) a fraction of the inventory, expressed in the unit,
(iv) a contract period, over which the size of the inventory will be determined,
(v) a settling date, and
(vi) a price per unit, on the settling date, for the fraction of the inventory, and
(b) a second computer connected to the computer network and having a user interface for generating a viewable report comprising the contract terms and communicating acceptance of the fractional forward contract.
